(19) United States
(12) Patent Application Publication
(10) Pub. No.: US 2017/0210524 A1
(43) Pub. Date: Jul. 27, 2017

(54) MOTION SENSOR FOR CASE

(71) Applicant: TKL Products Corp., Oilville, VA (US)

(72) Inventor: Thomas P. Dougherty, Oilville, VA (US)

(73) Assignee: TKL Products Corp., Oilville, VA (US)

(21) Appl. No.: 15/411,530

(22) Filed: Jan. 20, 2017

Related U.S. Application Data
(60) Provisional application No. 62/281,550, filed on Jan. 21, 2016.

(51) Int. Cl. B65D 51/24; G10G 5/00; G10G 7/00; B65D 43/16

(52) U.S. Cl. CPC B65D 51/245; B65D 43/163; G10G 5/00; G10G 7/00; G01P 15/001

(57) ABSTRACT

A case for holding an article includes a base, a lid having a first side and a second side opposite the first side, such that the lid is connected to the base at the first side and the lid and base together define an enclosed environment when the case is closed. A monitoring device is included that has an accelerometer, a humidity sensor, and a temperature sensor. The monitoring device is attached to the lid such that the monitoring device is in communication with the enclosed environment when the case is closed. The device can be used to detecting tampering with the case and can be installed permanently in the case.

### CROSS-REFERENCE TO RELATED APPLICATIONS

The present application claims the benefit of the filing date of U.S. Provisional Patent Application No. 62/281,550 filed Jan. 21, 2016, the disclosure of which is hereby incorporated herein by reference.

### BACKGROUND OF THE INVENTION

The present invention generally relates to cases for holding articles, and more particularly to a case for holding an article and monitoring its movement and its internal environment through the use of a monitoring device including an accelerometer.

Digital devices exist to detect temperature, humidity, and impact. These devices are useful when connected or used with a guitar. Controlling humidity and temperature levels is important for the performance of a guitar. It can also be useful to understand the impacts to a guitar. Recent developments have linked these digital devices wirelessly to a user interface, such as an interface or app on a mobile phone, so that the information detected by the digital device can be displayed to the user. This allows for conditions associated with temperature, humidity, and impact to be monitored and recorded, which can alert the user to risk of damage to the guitar. In other applications, similar digital devices have been developed that can be put in or clipped to a guitar case where the same types of conditions can be monitored.

While these types of devices are useful, additional features and functionalities are desired. In particular, there is a need for detection of tampering or other unintended uses associated with cases for guitars and other items. There is also a need for a device that can be permanently installed in a case to carry out such detection.

### SUMMARY OF THE INVENTION

A first aspect of the present invention is a case for holding an article, the case including a base, a lid having a first side and a second side opposite the first side, the lid being connected to the base at the first side such that the lid and base together define an enclosed environment when the case is closed, and a monitoring device including an accelerometer, a humidity sensor, and a temperature sensor, wherein the monitoring device is attached to the lid such that the monitoring device is in communication with the enclosed environment when the case is closed.

In accordance with other embodiments of the first aspect, the device may be permanently installed within the lid. The monitoring device may be secured to an inner surface of the lid. A housing of the monitoring device may be secured to the inner surface of the lid with screws. The lid may be connected to the base via a hinge at a first outer edge of the lid at the first side, and a second outer edge of the lid at the second side may pivot towards and away from the base about an axis defined by the hinge. The monitoring device may be attached to the lid at a location that is closer to the second edge than to the first edge. The monitoring device may be attached to the lid within 5 inches of the second edge. The monitoring device may be attached to the lid at least 10 inches away from the first edge. The monitoring device may be attached to the lid at least 10 inches away from the closest point on the first edge. The monitoring device may be attached to the lid at least 10 inches away from the hinge. The monitoring device may be attached to the lid at a location away from the first edge that is about 75% of the distance from the first edge to the second edge. The monitoring device may be attached to the lid at a location away from the first edge that is about 50% of the distance from the first edge to the second edge.

The humidity sensor may be configured to detect humidity within the enclosed environment of the case. The temperature sensor may be configured to detect temperature within the enclosed environment of the case. The accelerometer may be configured to detect opening and closing of the lid. The accelerometer may be configured to detect arc-shaped motion of the monitoring device about an axis defined by the hinge. The base and lid may be shaped to secure a musical instrument in the enclosed environment. The device may include a GPS device to convey information related to its location.

A second aspect of the present invention is a method of detecting tampering with a case for holding an article, including the steps of collecting information regarding a first impact with an accelerometer of a monitoring device attached to a lid of the case, the case including a base, the lid connected to the base at a first side of the lid, the lid having a second side opposite the first side, the lid and base together defining an enclosed environment when the case is closed, wherein the monitoring device is in communication with the enclosed environment when the case is closed, determining whether the magnitude of the first impact is greater than or equal to a first magnitude, collecting information regarding a second impact with the accelerometer, determining whether the magnitude of the second impact is greater than or equal to a second magnitude, and determining whether the second impact occurred within a first amount of time after the first impact.

In accordance with other embodiments of the second aspect, the first amount of time may be two seconds. The first amount of time may be one second. The first amount of time may be one-half second. If the magnitude of the first impact is greater than or equal to the first magnitude, if the second impact is greater than or equal to the second magnitude, and if the second impact occurred within the first amount of time after the first impact, then the method further include the steps of collecting information regarding arc-shaped movement of the monitoring device with the accelerometer, and determining whether the arc-shaped movement occurred within a second amount of time after the second impact. The method may further include a step of generating an alert if it was determined that the arc-shaped movement occurred within the second amount of time after the second impact. The second amount of time may be two seconds. The second amount of time may be one second. The second amount of time may be one-half second.

The first magnitude may be 2g's. The second magnitude may be 2g's. The monitoring device may further include a humidity sensor, and the method may further include the step of detecting a value of the humidity within the enclosed environment of the case. The monitoring device may further include a temperature sensor, and the method may further include the step of detecting a value of the temperature within the enclosed environment of the case.

A third aspect of the present invention is a method of equipping a case for holding an article to detect tampering, including the steps of attaching a monitoring device including an accelerometer to a lid of the case such that the monitoring device is in communication with an enclosed environment when the case is closed, the lid connected to a base of the case at a first side of the lid, the lid having a second side opposite the first side, the lid and base together defining the enclosed environment when the case is closed.

In accordance with other embodiments of the third aspect, the step of attaching may include permanently installing the monitoring device within the lid. The step of attaching may include securing the monitoring device to an inner surface of the lid. The step of securing may include securing a housing of the monitoring device to the inner surface of the lid with screws. The step of attaching may include locating the monitoring device at a location on the lid such that the accelerometer is positioned to detect arc-shaped motion of the monitoring device about an axis defined by a hinge at which the lid is connected to the base.

A fourth aspect of the present invention is a case for holding an article, the case including a base, a lid having a first side and a second side opposite the first side, the lid being connected to the base at the first side such that the lid and base together define an enclosed environment when the case is closed, and a monitoring device including an accelerometer, a humidity sensor, and a temperature sensor, wherein the lid is connected to the base via a hinge at a first outer edge of the lid at the first side, and a second outer edge of the lid at the second side pivots towards and away from the base about an axis defined by the hinge, and wherein the monitoring device is secured to an inner surface of the lid with screws at a location away from the first edge that is about 50% of the distance from the first edge to the second edge such that the monitoring device is in communication with the enclosed environment when the case is closed.

### BRIEF DESCRIPTION OF THE DRAWINGS

FIG. 1 is a top view of a guitar case having a sensor device in accordance with a first embodiment of the present invention.

FIG. 2 is a perspective view of the guitar case shown in FIG. 1 in an open configuration.

FIG. 3 is an exploded view of a housing for the sensor device of the guitar case shown in FIG. 1.

FIG. 4 depicts an exemplary system including a case having a sensor device.

FIG. 5 depicts an exemplary algorithm in a flow chart.

### DETAILED DESCRIPTION

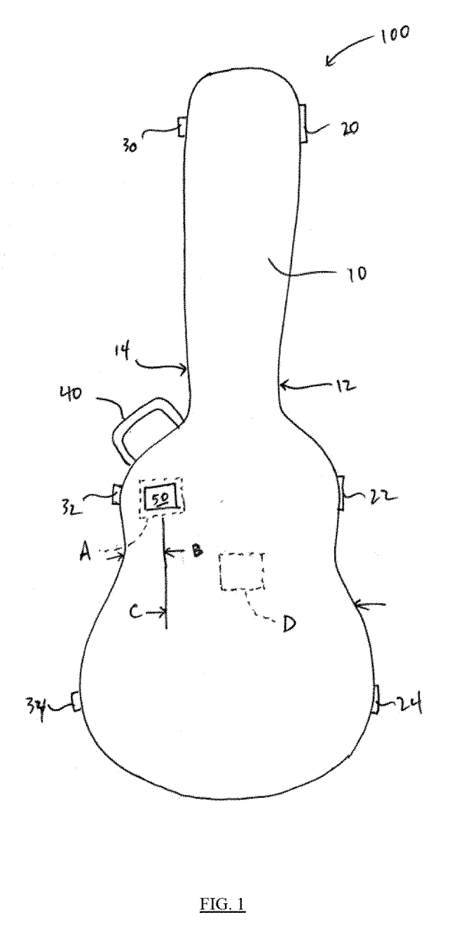

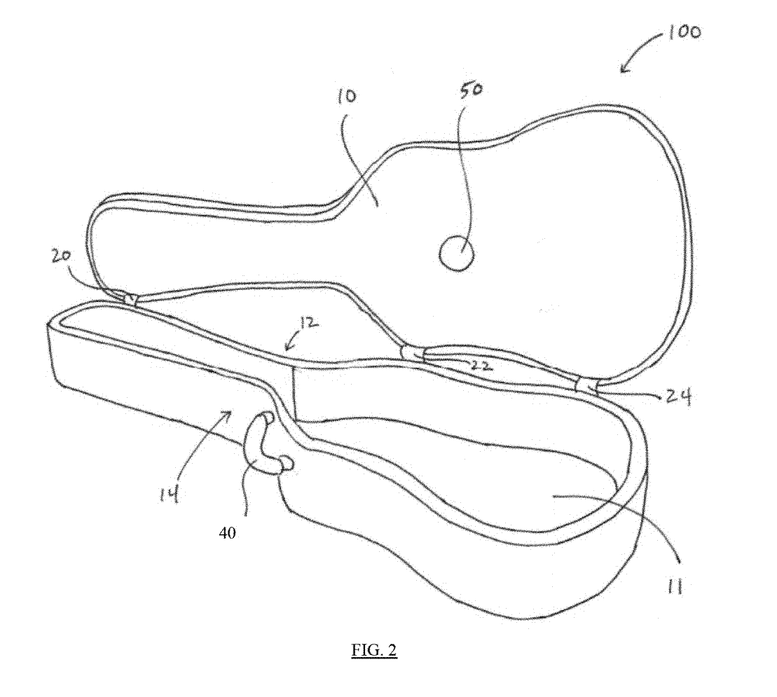

A first embodiment in accordance with the present invention is shown in FIGS. 1 and 2 as a case 100, which is configured for holding a guitar. Case 100 includes a base 11 and a lid 10. Lid 10 has a first side 12 and an opposite second side 14 separated from first side 12. Lid 10 is connected to base 11 at first side 12, for example via a hinge. Other connection methods are also contemplated that allow lid 10 to open with respect to base 11, including configurations in which lid 10 is completely removable from base 11. Together, lid 10 and base 11 define an enclosed environment when case 100 is closed.

Hinges 20, 22, 24 are located along a first outer edge of lid 10 at first side 12. Latches 30, 32, and 34 are also located along a second outer edge of lid 10 at second side 14 for securing lid 10 to base 11. The second outer edge at second side 14 pivots towards and away from base 11 about an axis defined by hinges 20, 22, 24. A handle 40 is also provided. The view of case 100 in FIG. 1 is from the top such that only a lid 10 of the case is shown.

A monitoring device 50 is attached to lid 10, such as by being secured to an inner surface of lid 10 with screws, adhesive, Velcro, or another means, such that device 50 is in communication with the enclosed environment when case 100 is closed. Device 50 includes an accelerometer, a humidity sensor, and a temperature sensor. In other embodiments, any one or more of these sensors and/or other types of detection can be included in the capabilities of device 50. In some embodiments, device 50 is permanently installed within lid 10 such that it can be included as part of the manufacture of case 100. In other embodiments, device 50 can be manufactured separately and installed into lid 10 of case 100 in a permanent manner, or at least in a manner in which device is secured to lid at a fixed location and cannot be easily removed or fall out of place under normal movement of case 100. Device 50 should be mounted to or within lid 10 so that it is anchored to a certain point of case 100. Permanent or removably secure installation allows device 50 to operate at a particular location of case 100 without the user having to remember to provide and place it inside case 100 for every desired use of case 100.

The location at which device 50 is installed influences its use and the information it can detect and provide to a user. As shown in FIG. 1, device can be installed at location A within lid 10, at or adjacent to second side 14 such that device 50 can detect opening and closing of lid 10. Location A is placed away from hinges 20, 22, 24 to enable device 50 to travel along a relatively large arc when lid 10 is opened from the base. Location A is closer to the second edge at second side 14 than to the first edge at first side 12. The further from hinges 20, 22, 24 or the axis along which hinges open that Location A and device 50 are disposed, the longer the arc along which device 50 travels, and thus the better able it is to detect movement or a change in location. Of course, if lid 10 is not hinged or even connected with base 11, device 50 can detect linear or other types of movement.

Location A is also relatively close to latches 30, 32, and 34 so that it can detect an impact related to the opening and closing of latches 30, 32, and 34. In one embodiment, Location A is within about 5 inches (shown in FIG. 1 as distance B) of the second edge of case 100 at second side 14. In another embodiment, Location A is at least about 10 inches (shown in FIG. 1 as distance C) from the first edge at first side 12, from the closest hinge, or from an axis about which the hinges rotate or about which lid 10 pivots with respect to base 11. In another embodiment, device 50 is attached to lid 10 at least about 10 inches away from the closest point on the first edge at first side 12. In another embodiment, device 50 is attached to lid 10 at least about 10 inches away from the closest one of hinges 20, 22, 24. In another embodiment, Location A is within about 3 inches of the second edge of case 100 at second side 14. In another embodiment, Location A is at least about 5 inches from the first edge at first side 12, from the closest hinge, or from an axis about which the hinges rotate or about which lid 10 pivots with respect to base 11. In another embodiment, device 50 is attached to lid 10 at least about 5 inches away from the closest point on the first edge at first side 12. In another embodiment, device 50 is attached to lid 10 at least about 5 inches away from the closest one of hinges 20, 22, 24. In another embodiment, device 50 is attached to lid 10 at a location away from the first edge at first side 12 that is about 75% of the distance from the first edge at first side 12 to the second edge at second side 14. In another embodiment, device 50 is attached to lid 10 at a location away from the first edge at first side 12 that is about 50% of the distance, or half way, between the first edge and the second edge. These distances are measured generally perpendicular to the axis about which lid 10 pivots with respect to base 11. In such an embodiment, device 50 can be installed at Location D at a central portion of lid 10 so that it aligns with the sound hole of the guitar. This position is also shown in FIG. 2 with device 50 depicted on an inner surface of lid 10. Other exact locations of device 50 can be utilized given a particular configuration of a case in which it is used.

The accelerometer in device 50 is configured to detect opening and closing of lid 10 with respect to base 11. That is, the accelerometer is configured to detect arc-shaped motion of device 50 about an axis defined by hinges 20, 22, 24. Device 50 also includes a humidity sensor configured to detect humidity within the enclosed environment of case 100 and a temperature sensor configured to detect temperature within the enclosed environment of case 100. Device 50 can also be configured to communicate with a second device installed on or in a guitar or other item disposed inside the case in which device 50 is installed. Those devices can optionally communicate with each other. The data provided by both devices can provide even more accurate information about the movement of the item and its case and whether tampering is occurring.

Another feature of device 50 is that it can be GPS-enabled to provide the user with real-time and historical information related to the location of device 50, and thus the case or item in which it is installed. This GPS enablement can be provided by dedicated hardware within the device. In other embodiments, this type of functionality can be provided by TKLOutdoors TRAKR™ System, a GPS and GSM enabled Asset Tracking and Locating System (ATLS) for use in all types of cases. The device can be modified to include the TKLOutdoors TRAKR™ System, or the case can be fitted with the TKLOutdoors TRAKR™ System separately. In either case, the positioning of the case can be conveyed to the user with the other information supplied by device 50. The TKL Outdoors TRAKR™ System allows a user to monitor an asset. It allows a user to create a secure, geo-fence zone for an item and receive alerts upon exit, entry or both within the established zone. The TKLOutdoorsTRAKR™ sends alerts via email, SMS and push notifications to iOS® and Android® devices.

As shown in FIGS. 1 and 2, base 11 and lid 10 of case 100 are shaped to secure a musical instrument in the enclosed environment. However, a case according to the present invention can be configured to hold many different types of articles. Cases according to the present invention can be carrying cases or bags and can be configured for cameras and other photographic equipment, laboratory equipment, firearms, ammunition, bottles such as bottled beverages, sporting equipment such as archery equipment, cigars, cigarettes, other tobacco products, and the like. Cases according to the present invention can also be designed as incubators, safes, vaults, burial vaults, display cases, and the like. Any other types of cases in which the functionality of device 50 is useful are also contemplated.

Case 100 uses a permanently-installed digital device in a location at which tampering types of movement can be detected and conveyed to the user via Bluetooth technology. Device 50 is located in the lid of the guitar case 100 away from the hinge. The further the device is located away from the axis about which the lid opens from the base of the case, the more motion will be detected by the device when the lid is opened and pivoted away from the base. That is, the device will travel along a longer arc when the case is opened, giving it the ability to more accurately pick up and convey this motion and the extent of the movement. With installation of the device inside the lid, the exact location of the device can be manipulated to significantly enhance the information obtained by the device. The device detects movement along with temperature, humidity, and impact. The device can have additional inputs and outputs.

The permanently installed device 50 is more accurate and beneficial than a loose device that is simply dropped into or clipped onto the inside of a case, such as for a guitar. This is because the precise location of the permanently installed device is important for the detection of information that is most useful for the intended purpose of detecting tampering. A loose device inside a case would not be in position to detect movement of the lid because it would not be anchored to a point on the lid and therefore would not be able to provide information that accurately conveys tampering use. A loose device may also shift during movement or opening of the case, which minimizes the usefulness of the information it returns.

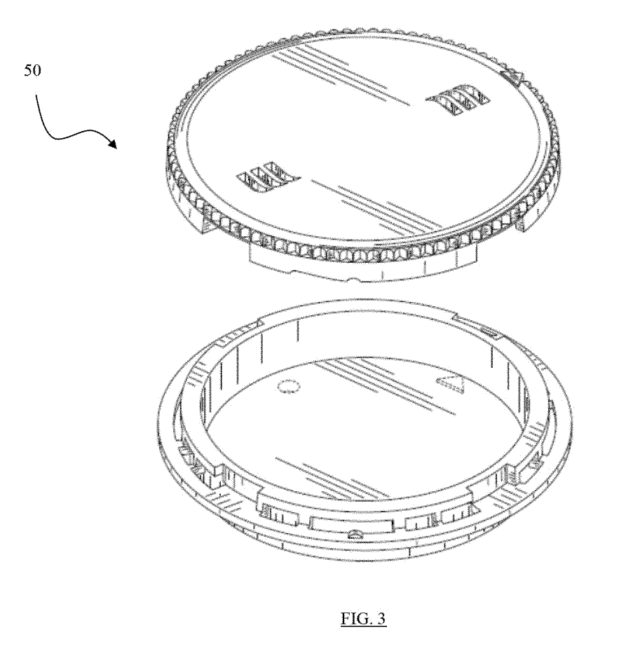

Other locations for the device could be in the lid of a guitar case and over the sound hole of the guitar, such as in FIG. 2. This allows for movement to be detected that accurately conveys information that can be used to detect tampering, while also allowing the temperature and humidity sensors, for instance, to be optimally placed for detection of such information on the inside of the guitar barrel. This central location can also more accurately detect impact at all locations of the case. The present devices are small, lightweight, and inexpensive to produce, making them beneficial over prior art devices. For example, a housing for device 50 is shown in FIG. 3. The housing can house electronic equipment that carries out the functionality of device 50.

Another embodiment of the present invention is an algorithm employed in connection with the information detected by the digital device that detects tampering activity. This algorithm allows the end user to utilize the existing hardware capabilities of an impact and motion sensing device to determine if the case in which the hardware is installed has been tampered with. The impacts which the algorithm is looking for are the slight impacts caused by the case latches being opened, followed by the motion of the case lid going through its natural opening arc.

The algorithm will trigger an alert when the hardware detects a series of two or more slight impacts within a specific timeframe, with the impacts being measured at or above 2g's, followed by the multi axis movement of the device. The alert will notify the user that the case in which the device has been installed, preferably in the lid or top of the case, is being tampered with, or has been tampered with, and that the case has most likely been opened, exposing the contents to the atmosphere and potentially some type of tampering or unintended use.

This method of detecting tampering with case 100 includes collecting information regarding a first impact with an accelerometer of device 50, which is attached to lid 10 of case 100 as indicated above. A comparison is made to determine whether the magnitude of the first impact is greater than or equal to a first magnitude, which can be about 2g's for example. The accelerometer then identifies whether a second impact is detected, for which it also compares the detected magnitude to determine whether it is greater than or equal to a second magnitude, which can be about 2g's for example. The first and second magnitudes can vary and can be different values. It is then determined whether the second impact occurred after the first impact within a first amount of time, which can be two seconds, one second, or one-half second, for example. This type of analysis is meant to detect opening of the latches of case 100, for example. Other thresholds of time, force, and magnitude can be utilized as desired to implement this method into a specific scenario.

If it is found that first and second impacts were of a magnitude greater than the noted thresholds, and if they occurred within the predetermined amount of time, then the accelerometer can collect information regarding movement, such as arc-shaped movement, of the monitoring device. This would be the type of movement that would indicate an opening of lid 10 of case 100. It can then be determined whether such movement occurred after the second impact within a second amount of time, which can be two seconds, one second, or one-half second, for example. If so, an alert can be generated by the accelerometer or other software in device 50 to advise a user of the detected information. The parameters of time and magnitude can be set by a user based on a particular application of device 50. Then, an alert to the user, whether wirelessly, over the internet, via Bluetooth, etc., can be received on a handheld or other device that lets the user know some type of tampering or unauthorized use may have taken place.

If device 50 includes a humidity and/or temperature sensor, the process can involve detecting and relaying values of humidity and/or temperature to the user. Thresholds can also be established for humidity and/or temperature so that automatic alerts are sent to the user if the measured values fall above and/or below certain predetermined levels within the enclosed environment of case 100.

A method of equipping case 100 for holding an article to detect tampering involves attaching device 50, which includes an accelerometer, to lid 10 of case 100 such that device 50 is in communication with an enclosed environment when the case is closed. Attaching device 50 to lid 10 can include permanently installing device 50 within lid 10, and securing device 50 to an inner surface of lid 10 with screws, adhesive, Velcro, or the like. Device 50 is placed in a location on lid 10 such that the accelerometer is positioned to detect arc-shaped motion of the monitoring device about an axis defined by a hinge at which lid 10 is connected to base 11.

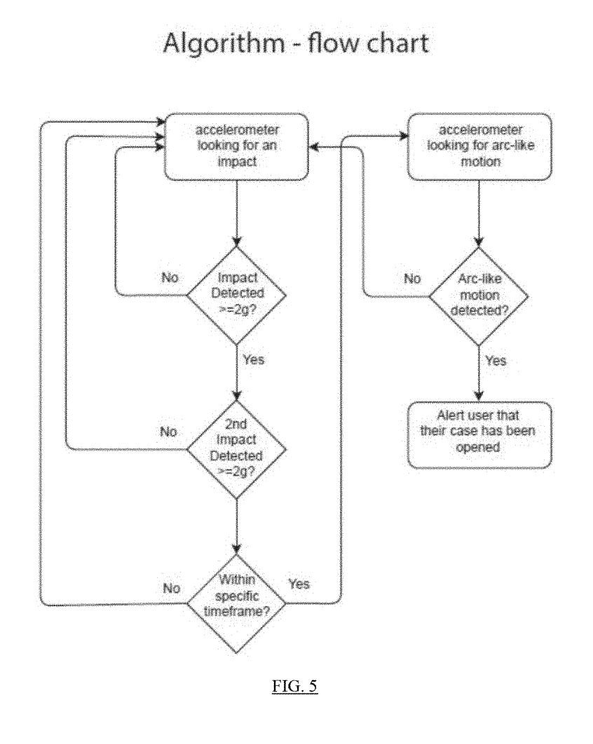

One exemplary algorithm according to the present invention is provided in the flow chart of FIG. 5. In that flow chart, the accelerometer first aims to detect an impact. Once an impact is detected, the accelerometer determines whether such impact was greater than or equal to about 2g's. The accelerometer then aims to determine whether a second impact of such magnitude has been generated. If so, the device determines whether the two qualifying impacts occurred within a specific time frame, such as within about 2 seconds. In other cases, that time frame can be within 1 second, or even within 0.5 seconds. Once the impacts are determined to be within the specified time frame, the accelerometer aims to detect an arc-like motion. If such motion is detected, particularly within a specified time after the detection of the two impacts, the device can generate an alert to be sent to the user to indicate that the case has been opened. The specified time frame in which the accelerometer looks for the arc-like motion is within about 2 seconds. In other cases, that time frame can be within 1 second, or even within 0.5 seconds. Of course, these times can be lengthened or shortened based on a user's particular operation of the algorithm based on need.

The contents of the case can be further confirmed to have been exposed to the atmosphere via a sub-algorithm by looking for a sudden change in temperature and/or humidity utilizing hardware sensors in devices equipped with such sensors. That is, the device can detect quantifiable changes in humidity and temperature that can be conveyed to the end user. In one embodiment, a change in temperature of about 10 or more degrees can trigger an alert. In another embodiment, a change in humidity of about 10% or more can trigger an alert.

A device can be placed inside the lid of a case. The latches of the case are then secured. The device can detect the g-forces generated by the motion of the latches being opened and/or closed. Detection, recordation, and transmission of a g-force event, resulting from opening two latches in close succession, can determine that the case's latches were opened. Further, with the device installed in the lid of the case, even the slightest motion of the case lid can be detected as it moves in an arc-like motion.

From this information, an algorithm is provided that detects, analyzes, and transmits the recorded events. This provides a new and unique tamper-detection feature such that the device can provide an extremely valuable alert, notifying the end-user that the case had experienced an opening. This is due the fact that the algorithm-enabled device is installed in the case lid, and particularly in a location in which the movement data can be sensitively recorded and accurately analyzed to detect tamper-like movement. This algorithm can effectively enable the same functionality in any type of case.

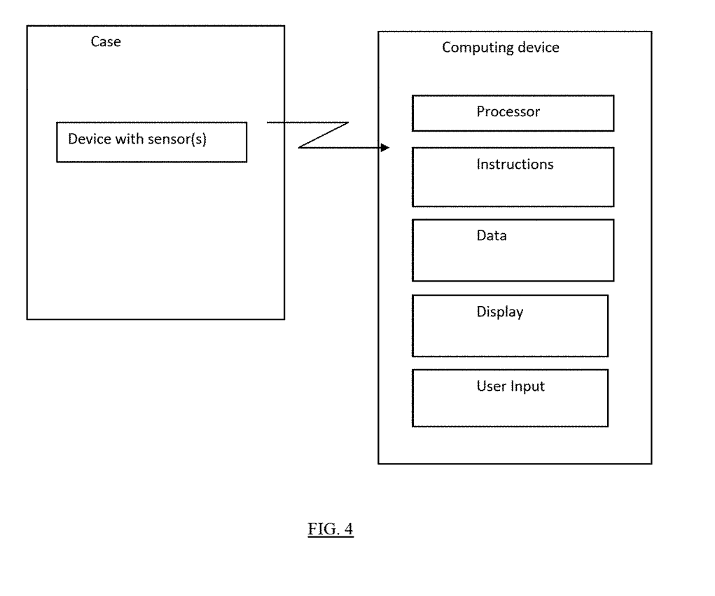

As shown in FIG. 4, an exemplary system includes a case in which a device 50 as described above is installed. The device can communicate with a computing device, such as a computer or mobile phone of a user. The connection can be via Bluetooth or another wireless or wired transmission. The device can utilize its sensors to gather information and transmit that data to the computing device. The computing device includes a processor and a set of instructions, as explained in connection with the algorithm disclosed herein. Those instructions can read the data provided from the device to display information on the computing device. That information can include alerts regarding potential tampering activity, and can also include status updates for normal or other activity or inactivity. The computing device can also include a user input to respond to alerts or forward them to another device.

While the above discussion relates to a case for a guitar, other cases are contemplated, such as those for other musical instruments, guns, documents, etc.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A case for holding an article, the case comprising:
a base;
a lid having a first side and a second side opposite the first side, the lid being connected to the base at the first side such that the lid and base together define an enclosed environment when the case is closed; and
a monitoring device including an accelerometer, a humidity sensor, and a temperature sensor;
wherein the monitoring device is attached to the lid such that the monitoring device is in communication with the enclosed environment when the case is closed.

2. The case of claim 1, wherein the device is permanently installed within the lid.

3. The case of claim 1, wherein the monitoring device is secured to an inner surface of the lid.

4. The case of claim 3, wherein a housing of the monitoring device is secured to the inner surface of the lid with screws.

5. The case of claim 3, wherein a housing of the monitoring device is secured to the inner surface of the lid with adhesive.

6. The case of claim 3, wherein the device includes a GPS device to convey information related to its location.

7. The case of claim 1, wherein the lid is connected to the base via a hinge at a first outer edge of the lid at the first side, and a second outer edge of the lid at the second side pivots towards and away from the base about an axis defined by the hinge.

8. The case of claim 7, wherein the monitoring device is attached to the lid at a location that is closer to the second edge than to the first edge.

9. The case of claim 7, wherein the monitoring device is attached to the lid within 5 inches of the second edge.

10. The case of claim 7, wherein the monitoring device is attached to the lid at least 10 inches away from the first edge.

11. The case of claim 7, wherein the monitoring device is attached to the lid at least 10 inches away from the closest point on the first edge.

12. The case of claim 7, wherein the monitoring device is attached to the lid at least 10 inches away from the hinge.

13. The case of claim 7, wherein the monitoring device is attached to the lid at a location away from the first edge that is about 75% of the distance from the first edge to the second edge.

14. The case of claim 7, wherein the monitoring device is attached to the lid at a location away from the first edge that is about 50% of the distance from the first edge to the second edge.

15. The case of claim 1, wherein the humidity sensor is configured to detect humidity within the enclosed environment of the case.

16. The case of claim 1, wherein the temperature sensor is configured to detect temperature within the enclosed environment of the case.

17. The case of claim 1, wherein the accelerometer is configured to detect opening and closing of the lid.

18. The case of claim 1, wherein the accelerometer is configured to detect arc-shaped motion of the monitoring device about an axis defined by the hinge.

19. The case of claim 1, wherein the base and lid are shaped to secure a musical instrument in the enclosed environment.

20. A case for holding an article, the case comprising:
a base;
a lid having a first side and a second side opposite the first side, the lid being connected to the base at the first side such that the lid and base together define an enclosed environment when the case is closed; and
a monitoring device including an accelerometer, a humidity sensor, and a temperature sensor;
wherein the lid is connected to the base via a hinge at a first outer edge of the lid at the first side, and a second outer edge of the lid at the second side pivots towards and away from the base about an axis defined by the hinge, and
wherein the monitoring device is secured to an inner surface of the lid with screws at a location away from the first edge that is about 50% of the distance from the first edge to the second edge such that the monitoring device is in communication with the enclosed environment when the case is closed.
